(19) United States
(12) Patent Application Publication
(10) Pub. No.: US 2011/0131518 A1
(43) Pub. Date: Jun. 2, 2011

(54) CONTROL APPARATUS AND CONTROL METHOD

(75) Inventor: Shikyo OHASHI, Ome-shi (JP)

(73) Assignee: Kabushiki Kaisha Toshiba, Tokyo (JP)

(21) Appl. No.: 12/957,170

(22) Filed: Nov. 30, 2010

(30) Foreign Application Priority Data
Nov. 30, 2009 (JP) 2009-272777

(51) Int. Cl. G06F 3/048

(52) U.S. Cl. 715/769

(57) ABSTRACT

According to one embodiment, a control apparatus includes a display module configured to display a window in a first window state or a second window state on a display screen of a display device, the display module displaying a server object corresponding to a digital media server in a first area of the window and a renderer object corresponding to a digital media renderer in a second area of the window when the window in the first window state is displayed, the display module displaying the window in the second window state when the server object is selected, the display module displaying one or more content objects corresponding to the one or more digital media contents in the first area and the renderer object in the second area when the window in the second window state is displayed.

### CROSS-REFERENCE TO RELATED APPLICATIONS

This application is based upon and claims the benefit of priority from Japanese Patent Application No. 2009-272777, filed Nov. 30, 2009; the entire contents of which are incorporated herein by reference.

### FIELD

Embodiments described herein relate generally to a content distribution system configured to transmit contents from a server to a renderer through a network to carry out playback of the content, and more particularly, to a control apparatus configured to carry out control of the server and renderer, and control method used in the control apparatus.

### BACKGROUND

A function of carrying out identification, management, and distribution of media content between devices connected to a customer premises network is realized by Universal Plug and Play Audio and Video (UPnP AV).

As a standard employing UPnP AV, there is Digital Living Network Alliance (DLNA). In DLNA, a 3-BOX model constituted of a digital media server configured to distribute digital media content, digital media renderer configured to play back digital media content, and digital control point configured to carry out control of the digital media server and digital media renderer is conceived. As the control point, for example, a cellular phone, personal computer or the like is used.

In Jpn. Pat. Appln. KOKAI Publication No. 2008-71193, it is described that even in a situation where a music file desired to be transferred is displayed on a list screen of folder content, transfer of the music file to a music playback apparatus is executed by drag-and-drop.

Incidentally, UPnP AV is supported by Windows® 7. For example, when Windows Media Player of Windows 7 is to be used, content stored in the server are selected, thereafter a pop-up menu is displayed by clicking the right mouse button, and a digital media renderer device is selected from the “Play to” menu, whereby it is possible to play back the content by the digital media renderer device. However, it is not easily possible to grasp the existence of the digital media renderer device existing on the network, and there has been a problem in the operability.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary block diagram showing the configuration of a media playback system according to an embodiment.

FIG. 2 is an exemplary block diagram showing the system configuration of a notebook personal computer according to the embodiment.

FIG. 3 is an exemplary block diagram showing the configuration of a UPnP AV device control module according to the embodiment.

FIG. 4 is an exemplary view showing a window in which server objects corresponding to media servers, and renderer objects corresponding to digital media renderers are displayed.

FIG. 5 is an exemplary view showing a window in which content objects and renderer objects corresponding to content stored in the media server are displayed.

FIG. 6 is an exemplary view showing a state where a content object is drag-and-dropped to a renderer object.

FIG. 7 is an exemplary view showing a state where video-1 is played back.

FIG. 8 is an exemplary view showing a window in which a name of content played back by a first renderer is displayed.

FIG. 9 is an exemplary block diagram showing the system configuration of a digital media renderer according to the embodiment.

FIG. 10 is an exemplary block diagram showing the configuration of a UPnP renderer control module according to the embodiment.

FIG. 11 is an exemplary block diagram showing the configuration of a media server according to the embodiment.

FIG. 12 is an exemplary flowchart showing the procedure for playing back content according to the embodiment.

### DETAILED DESCRIPTION

Various embodiments will be described hereinafter with reference to the accompanying drawings.

In general, according to one embodiment, a control apparatus includes a server detector, a renderer detector, an information acquisition module, a display module, an operation module, and a command transmission module. The server detector is configured to detect a digital media server connected to a network. The renderer detector is configured to detect a digital media renderer connected to the network. The information acquisition module is configured to acquire content information from the digital media server, the content information comprising one or more network addresses of one or more digital media contents comprised in the digital media server. The display module configured to display a window in a first window state or a second window state on a display screen of a display device, the display module displaying a server object corresponding to the digital media server in a first area of the window and a renderer object corresponding to the digital media renderer in a second area of the window when the window in the first window state is displayed, the display module displaying the window in the second window state when the server object is selected, the display module displaying one or more content objects in the first area and the renderer object in the second area when the window in the second window state is displayed, the one or more content objects corresponding to the one or more digital media contents comprised in the digital media server corresponding to the selected server object. The operation module configured to perform a drag-and-drop operation of a content object of the one or more content objects in accordance with a user operation when the window in the second window state is displayed, the drag-and-drop operation comprising dragging the content object and dropping the content object at the renderer object. The command transmission module configured to transmit, to the digital media renderer, a network address of a digital media content corresponding to the content object and a command to playback the digital media content, the digital media server corresponding to the renderer object at which the content object is dropped.

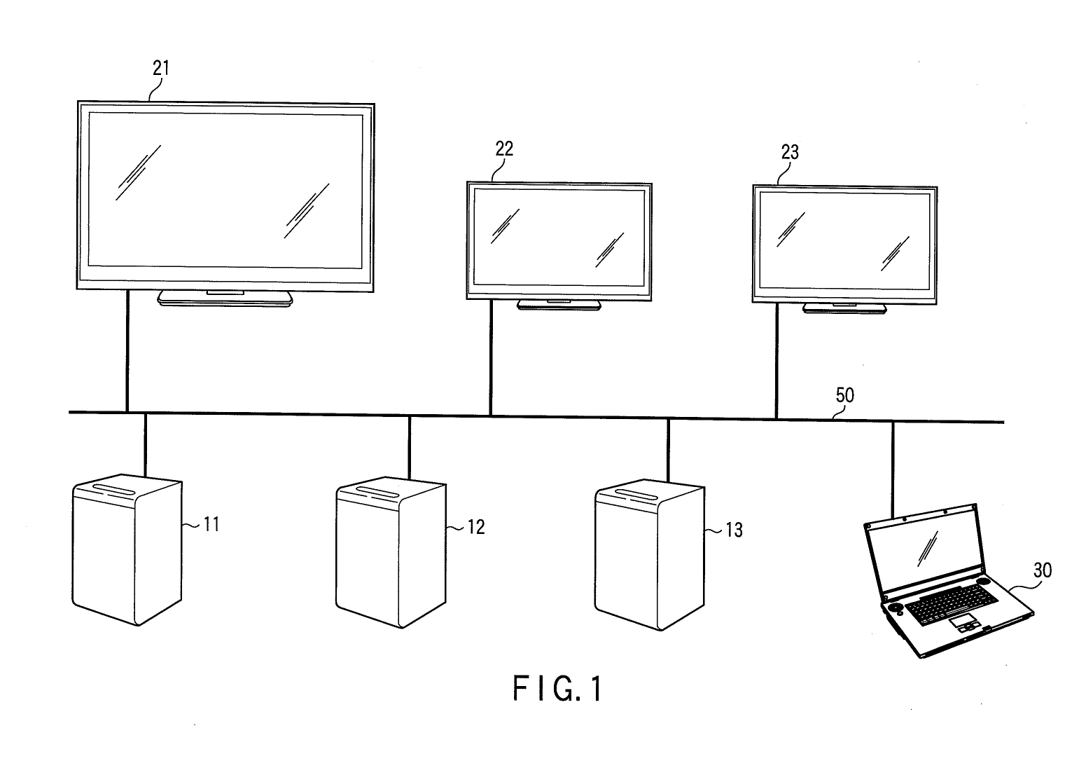

FIG. 1 is a block diagram showing the configuration of a media playback system according to an embodiment.

As shown in FIG. 1, this system is provided with a first media server 11, second media server 12, third media server 13, first media renderer 21, second media renderer 22, third media renderer 23, notebook personal computer 30, and the like.

Each of the first media server 11, second media server 12, and third media server serving as a digital media server (DMS) is provided with a storage device configured to store contents of the number of one or more, UPnP server control module, and the like.

The UPnP server control module distributes digital media content (hereinafter referred to as content) to any one of the first media renderer 21, second media renderer 22, and third media renderer 23 serving as a digital media renderer in accordance with an instruction of the computer 30.

Each of the first media renderer 21, second media renderer 22, and third media renderer 23 serving as a digital media renderer (DMR) has a function of playing back and displaying the content distributed thereto from any one of the first media server 11, second media server 12, and third media server 13.

The first media server 11, second media server 12, third media server 13, first media renderer 21, second media renderer 22, third media renderer 23, and computer 30 constitute a home network 50 based on TCP/IP. The devices of the first media server 11, second media server 12, third media server 13, first media renderer 21, second media renderer 22, third media renderer 23, and computer 30 carry out communication conforming to Universal Plug and Play Audio and Visual (UPnP AV) with each other, and carry out acquisition and control of attribute information, and capability information of each device or content information held by each device, whereby it is possible to carry out playback or the like of content.

In the communication between the devices, UPnP AV is used to carry out acquisition and control of attribute information, and capability information of each device or content information held by each device, whereby it is possible to carry out playback or the like of the content.

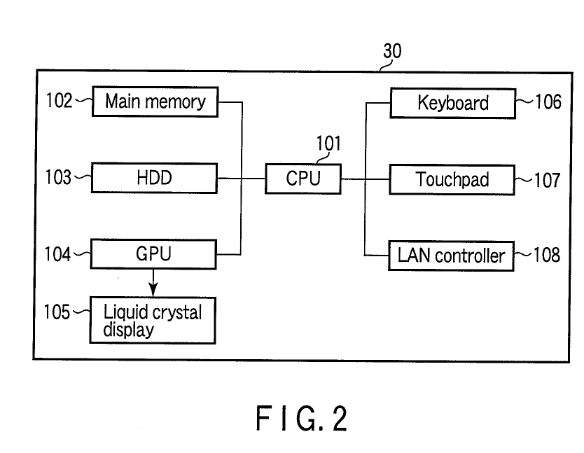

First, the configuration of the computer 30 will be described below with reference to FIG. 2. FIG. 2 is a block diagram showing the system configuration of the computer 30 according to the embodiment.

As shown in FIG. 2, the computer 30 is provided with a Central Processing Unit (CPU) 101, main memory 102, hard disk drive (HDD) 103, Graphics Processing Unit (GPU) 104, liquid crystal display 105, keyboard 106, touch pad 107, LAN controller 108, and the like.

The CPU 101 is a processor configured to control an operation of the computer 30, and executes an operating system (OS), and various application programs such as a web browser, and the like loaded into the main memory 102.

A flash memory 103 is a storage place of execution files such as the operating system, and various application programs, and data files acquired by the user.

The GPU 104 is a display controller configured to control the liquid crystal display 105 used as a display device of the computer 30. A display signal produced by the GPU 104 is sent to the liquid crystal display 105.

The keyboard 106 is provided to input characters in accordance with an operation of the user. The touch pad 107 is provided to operate an icon (object) and the like displayed on the display screen of the liquid crystal display 105 in accordance with the operation of the user. A drag-and-drop operation is carried out by using the touch pad 107 in accordance with the operation of the user.

The LAN controller 108 carries out communication with the first to third media servers 11 to 13, and first to third media renderers 21 to 23 connected to the home network 50.

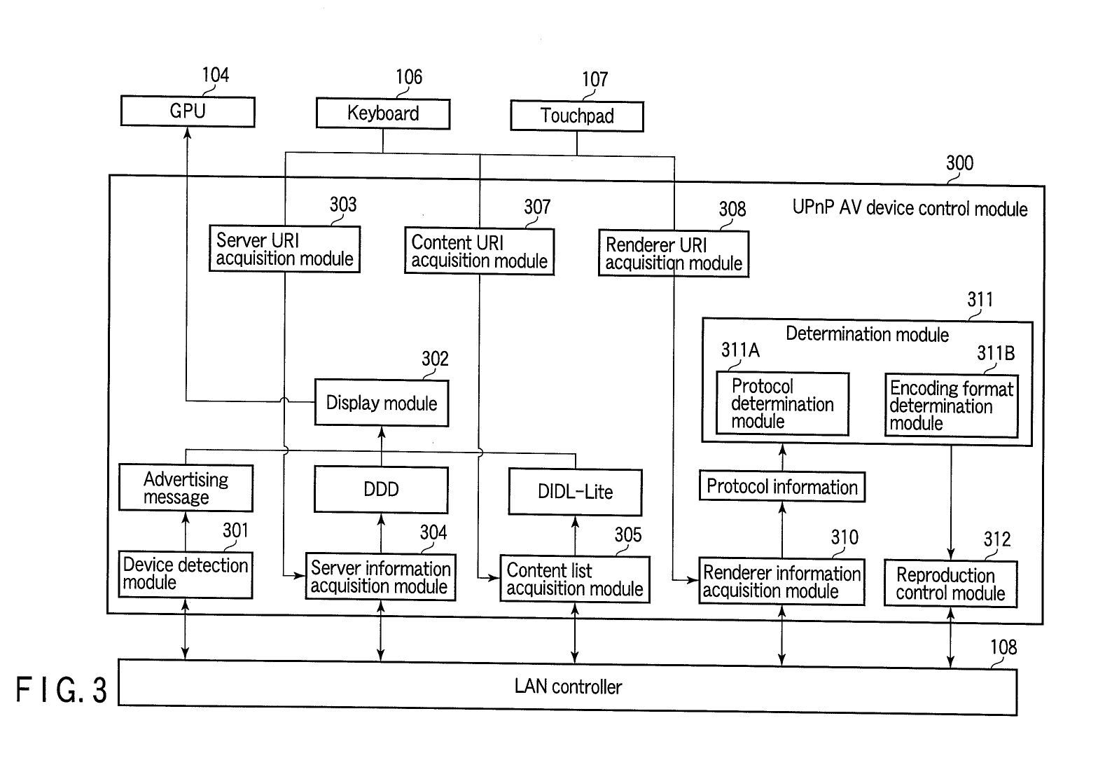

Next, the configuration of a UPnP AV device control module 300 compatible with UPnP configured to control playback of content stored in the media server to be carried out by the CPU 101 will be described below with reference to FIG. 3. FIG. 3 is a block diagram showing the configuration of the UPnP AV device control module 300 according to the embodiment.

The UPnP AV device control module 300 is provided with a device detection module 301, display module 302, server URI detection module 303, content list acquisition module 305, content URI detection module 307, renderer URI acquisition module 308, renderer identifier acquisition module 309, renderer information acquisition module 310, determination module 311, playback control module 312, and the like.

The device detection module 301 sends an M-SEARCH message defined by the Simple Service Discovery Protocol (SSDP) to the home network 50 by multicast transmission. Each of the devices compatible with UPnP (first to third media servers 11 to 13, and first to third media renderers 21 to 23) which have received the M-SEARCH message transmits information indicating a service (server, renderer or the like) provided by the device, information indicating a position of the device on the home network 50 such as a URI (IP address and port number) or the like to the computer 30 which has transmitted the M-SEARCH message by including the information in an advertising message. The device detection module 301 detects the devices connected to the home network 50 such as the media servers and media renderers by receiving the advertising message. Further, the device detection module 301 distinguishes between the media server and media renderer in accordance with the service provided by the device included in the advertising message to determine whether the device is a media server or a media renderer.

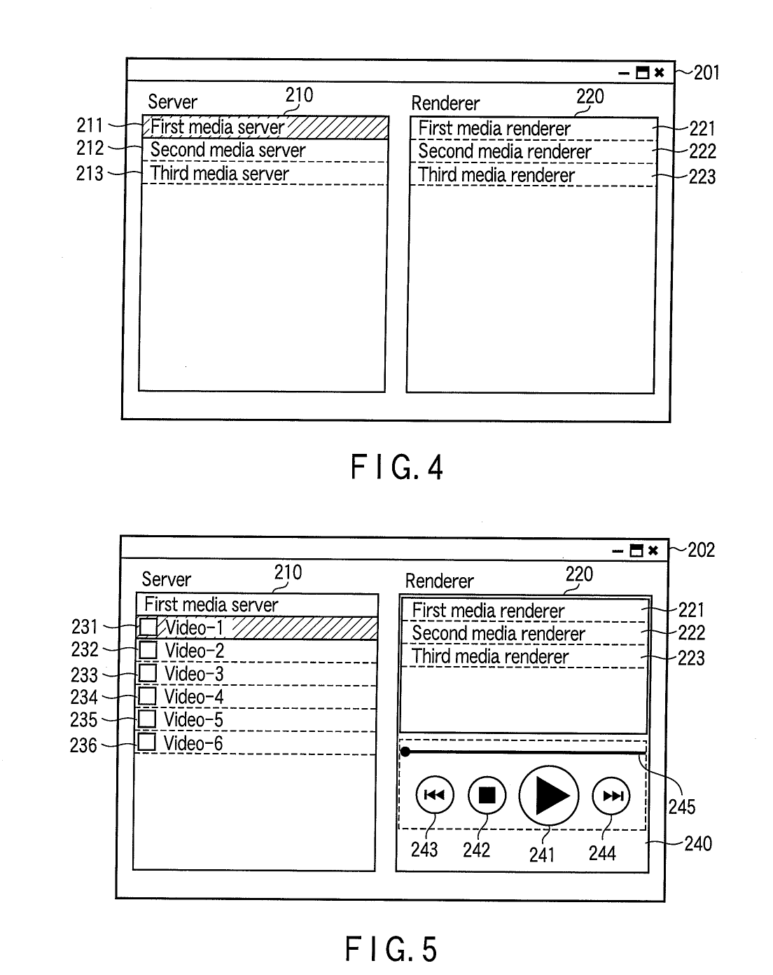

The display module 302 produces data used for displaying a window in which an object corresponding to the media renderer or the media server detected by the device detection module 301 is to be displayed on the display screen of the liquid crystal display 105, the window being in a first state. The window is displayed on the display screen of the liquid crystal display 105. An example of the window displayed on the basis of the data produced by the display module 302 is shown in FIG. 4.

As shown in FIG. 4, server objects corresponding to the media servers detected by the device detection module 301 are displayed in a first area 210 of a window 201. In the case of this embodiment, a first server object 211, second server object 212, and third server object 213 are displayed. It should be noted that information such as a name, and URI included in the advertising message transmitted from the first media server 11 is directly or indirectly correlated with the first server object 211. Further, information such as a name, and URI included in the advertising message transmitted from the second media server 12 is directly or indirectly correlated with the second server object 212. Further, information such as a name, and URI included in the advertising message transmitted from the third media server 13 is directly or indirectly correlated with the third server object 213. On the surface of each of the first to third server objects 211 to 213, the name of corresponding one of the first to third media servers 11 to 13 is displayed.

Further, renderer objects corresponding to the media renderers detected by the device detection module 301 are displayed in a second area 220 of the window 201. In the case of this embodiment, a first renderer object 221, second renderer object 222, and third renderer object 223 are displayed. It should be noted that information such as a name, and URI included in the advertising message transmitted from the first media renderer 21 is directly or indirectly correlated with the first renderer object 221. Further, information such as a name, and URI included in the advertising message transmitted from the second media renderer 22 is directly or indirectly correlated with the second renderer object 222. Further, information such as a name, and URI included in the advertising message transmitted from the third media renderer 23 is directly or indirectly correlated with the third renderer object 223. On the surface of each of the first to third renderer objects 221 to 223, the name of corresponding one of the first to third media renderers 21 to 23 is displayed.

A selected server URI detection module 303 detects a server object selected by the user from the server objects displayed on the liquid crystal display 105 by operating the keyboard 106 or touch pad 107. The server URI detection module 303 acquires a URI of the media server correlated with the server object. In this embodiment, it is assumed that the server URI detection module 303 has acquired a URI of the first server object 211.

A server information acquisition module 304 transmits an HTTP GET message by addressing the message to the URI (URI of the first media server 11) detected by the server URI detection module 303. The media server (first media server 11) which has received the HTTP GET message transmits a Device Description Document (DDD) in which device information and service information are described in the XML to the computer 30. The computer 30 acquires device information of the media server (first media server 11) by receiving the XML document transmitted from the media server (first media server 11).

A content list acquisition module 305 transmits a Browse action according to the Simple Object Access Protocol (SOAP) and Content Directory Service (CDS) to the URI of the media server (first media server 11) detected by the server URI detection module 303. The media server (first media server 11) which has received the Browse action transmits a Digital Item Declaration Language (DIDL)-Lite document including contents information on all the contents possessed by its own device. The DIDL-Lite document includes one or more combinations of a name of media contents, URI indicating the storage place of media content on the home network 50, transmission protocol information of media content, encoding format of media content, and information indicating a URI indicating the storage place of a thumbnail image of content on the home network 50.

The display module 302 produces data for displaying a window in which a content object corresponding to media content, and renderer object corresponding to a media renderer are to be displayed on the display 105, the window being in a second state, on the basis of the DIDL-Lite document received by the content list acquisition module 305.

An example of a list of media contents displayed by the display module 302, and window in which a list of media renderers is displayed is shown in FIG. 5. It should be noted that FIG. 5 shows the case where information on the first to sixth media contents is included in the DIDL-Lite document.

As shown in FIG. 5, a list of media contents included in the DIDL-Lite document is displayed in a first area 210 of a window 202. In the case of this embodiment, a first content object 231, second content object 232, third content object 233, fourth content object 234, fifth content object 235, and sixth content object 236 are displayed.

It should be noted that information such as a name (video-1) of the first media content, encoding format, and URI included in the DIDL-Lite document is directly or indirectly correlated with the first content object 231. Further, information such as a name (video-2) of the second media content, encoding format, and URI included in the DIDL-Lite document is directly or indirectly correlated with the second content object 232. Further, information such as a name (video-3) of the third media content, encoding format, and URI included in the DIDL-Lite document is directly or indirectly correlated with the third content object 233. Further, information such as a name (video-4) of the fourth media content, encoding format, and URI included in the DIDL-Lite document is directly or indirectly correlated with the fourth content object 234. Further, information such as a name (video-5) of the fifth media content, encoding format, and URI included in the DIDL-Lite document is directly or indirectly correlated with the fifth content object 235. Further, information such as a name (video-6) of the sixth media content, encoding format, and URI included in the DIDL-Lite document is directly or indirectly correlated with the sixth content object 236.

It should be noted that in a second area of the window 202, first to third renderer objects 221 to 223 are displayed in the same manner as FIG. 4. Further, in the second area 220 of the window 202, a control area 240 in which control buttons for carrying out playback control of content are displayed is provided. In the control area 240, a play/pause button 241, stop button 242, return button 243, advance button 244, and seek bar 245 are displayed. When the play/pause button 241 is operated, the play/pause of the content is carried out. When the stop button 242 is operated, the playback stop of content is carried out. When the return button 243 is short-press-operated, the display is returned to the previous chapter of content. Further, when the return button 243 is long-press-operated, fast reverse playback of content is carried out. When the advance button 244 is short-press-operated, the display is advanced to the next chapter of content. Further, when the advance button 244 is long-press-operated, fast forward playback of content is carried out. Further, when a position on the seek bar 245 is operated, the playback position is changed.

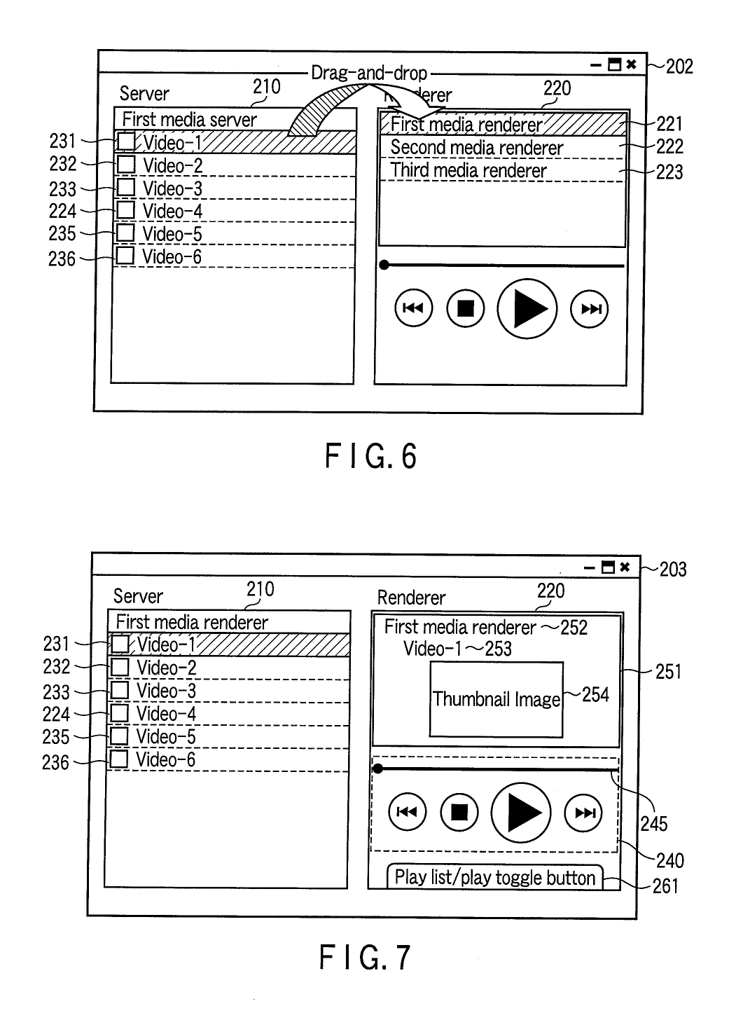

The case where a drag-and-drop operation in which the user operates the touch pad 107 to drag a content object to a renderer object, and thereafter drop the content object at the renderer object as shown in FIG. 6 is carried out will be described below.

The content URI acquisition module 307 acquires a URI correlated with a content object dragged by the user by an operation of the touch pad 107 from content objects 231 to 236 displayed on the liquid crystal display 105.

Further, the renderer URI acquisition module 308 acquires a URI correlated with a renderer object dropped by the user by an operation of the touch pad 107 from renderer objects 221 to 223.

The renderer information acquisition module 310 transmits a GetProtocolInfo request to the URI acquired by the renderer URI acquisition module 308. The renderer information acquisition module 310 receives protocol information transmitted by the playback apparatus including the transmission protocol and encoding format with which its own device is compatible according to the action.

The determination module 311 determines whether or not it is possible for the playback apparatus selected by the user to play back the media content selected by the user. The determination module 311 is provided with a protocol determination module 311A, encoding format determination module 311B, and the like. The protocol determination module 311A determines whether or not it is possible to transmit the media content from the media server to the playback apparatus on the basis of the transmission protocol with which the media server included in the DDD is compatible, and transmission protocol with which the playback apparatus included in the protocol information acquired by the renderer information acquisition module 310 is compatible. The encoding format determination module 311B determines whether or not it is possible for the playback apparatus to play back the media content on the basis of the encoding format of the media content included in the DIDL-Lite document, and encoding format with which the media renderer included in the renderer information acquired by the renderer information acquisition module 310 is compatible.

When it is determined by the protocol determination module 311A that it is possible to transmit the media content and, further it is determined by the encoding format determination module 311B that it is possible for the playback apparatus to play back the media content, the renderer information acquisition module 310 determines that it is possible for the playback apparatus selected by the user to playback the media content selected by the user. Further, when it is determined by the protocol determination module 311A that it is not possible to transmit the media content, or when it is determined by the encoding format determination module 311B that it is not possible for the playback apparatus to playback the media content, the renderer information acquisition module 310 determines that it is not possible for the playback apparatus selected by the user to playback the media content selected by the user.

In this embodiment, the protocol determination module 311A firstly carries out the determination processing. When it is determined by the protocol determination module 311A that it is possible to transmit the media content, the encoding format determination module 311B carries out the determination processing. However, the order in which the determination processing is carried out by each of the modules 311A and 311B may be reversed.

When it is determined by the determination module 311 that it is possible for the playback apparatus to play back the content, the playback control module 312 transmits, in order to play back media content, an action for causing the playback apparatus selected by the user to start transmission of the media content data to the playback apparatus.

FIG. 7 shows an example of a window displayed during playback. As shown in FIG. 7, what are displayed in the first area 210 in the window 203 are content objects 231 to 236 like the first area 210 of the window 202 shown in FIG. 6. Further, in the first area 210 of the window 204, a content information display area 251 indicating information on the content being played back is provided. In the content information display area 251, a name 252 of a media renderer playing back the content, name 253 of content being played back, and thumbnail image 254 of content being played back are displayed. The name 253 of the content being played back, and thumbnail image 254 are displayed on the basis of the information of the DIDL-Lite document.

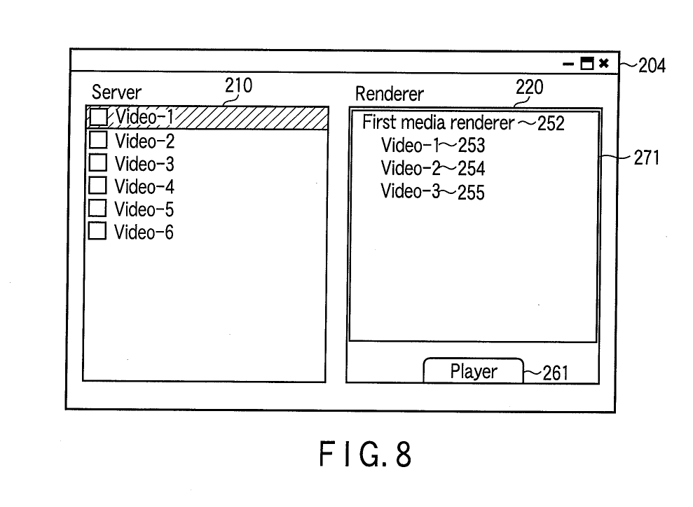

It should be noted that when the play list/play toggle button 261 in the second area 220 is operated, a playback content list area 271 is displayed in the second area 220 in place of the control area 240, and content information display area 251 as shown in FIG. 8. In the playback content list area 271, a name of a media renderer carrying out playback of contents, and names 253 to 255 of contents to be played back by the media renderer are displayed. In the example shown in FIG. 8, the case where the video-1, video 2, and video-3 are registered as content to be played back by a drag-and-drop operation is shown. Further, when the play list/play toggle button 261 in the second area of the window 204 shown in FIG. 8 is operated, the window 204 is switched to the window 203 shown in FIG. 7. That is, each time the play list/play toggle button 261 is operated, the window is switched between the window 203 shown in FIG. 7, and window 204 shown in FIG. 8.

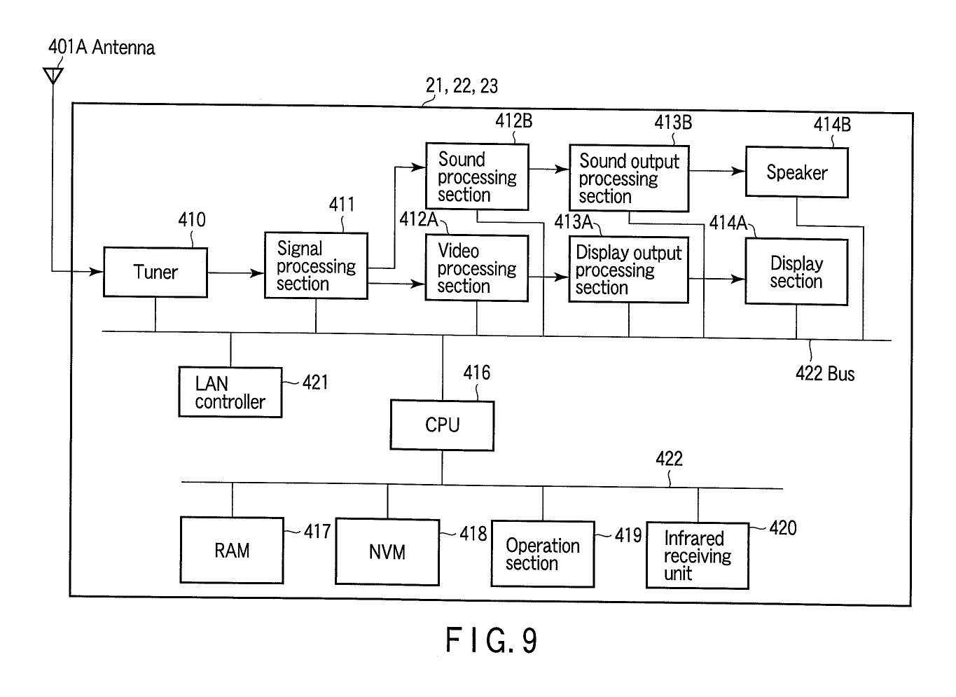

Next, the configuration of each of the first to third media renderers 21 to 23 will be described below with reference to FIG. 9. FIG. 9 is a block diagram showing the configuration of each of the first to third media renderers 21 to 23 according to the embodiment.

Each of the first to third media renderers 21 to 23 is provided with a tuner 410, signal processing section 411, video processing section 412A, display output processing section 413A, display section 414A, sound processing section 412B, sound output processing section 413B, speaker 414B, Central Processing Unit (CPU) 416, Random Access Memory (RAM) 417, nonvolatile memory 418, operation section 419, infrared receiving unit 420, LAN controller 421, and the like. The above sections are connected to each other through a bus 422.

The tuner 410 receives a digital terrestrial broadcast signal (broadcast signal), demodulates the broadcast signal, and outputs a program signal. The signal processing section 411 classifies the output of the tuner 410 or data input through the LAN controller 421 into types such as video data, sound data, subtitle data, and the like, and processes the classified data. The video processing section 412A decodes the output of the signal processing section 411 including that of the video data and subtitle data. The display output processing section 413A converts the output of the video processing section 412A into a video signal for display, and outputs the video signal. The display section 414A displays the output of the display output processing section 413A on a display screen of a liquid crystal display (LCD) or the like. The sound processing section 412B decodes the output of the sound data of the signal processing section 411. The sound output processing section 413B converts the output of the sound processing section 412B into a sound signal, and outputs the sound signal. The speaker 414B converts the output of the sound output processing section 413B into the sound. The CPU 416 controls each section of the first to third media renderers 21 to 23. The RAM 417 temporarily stores therein data to be processed by the CPU 416. The nonvolatile memory 418 records thereon data of firmware or the like in a nonvolatile state. The operation section 419 is constituted of a plurality of switches, and the like, and operates the television set 401 on the basis of the input of each of the switches and the like. The LAN controller 421 is a controller configured to carry out TCP/IP communication with the devices and apparatuses connected to the home network 50.

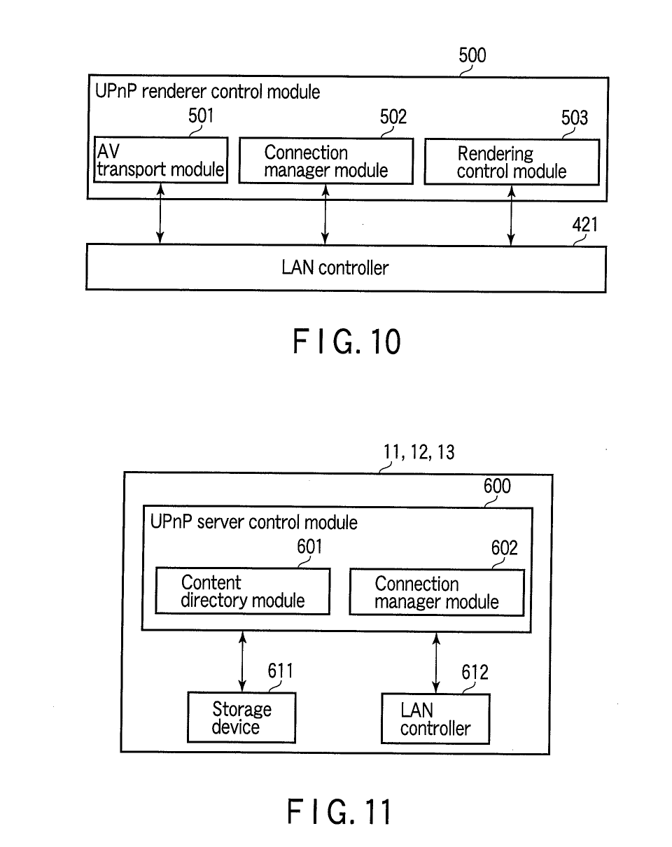

Next, the configuration of a UPnP renderer control module 500 will be described below with reference to FIG. 10. FIG. 10 is a block diagram showing the configuration of the UPnP renderer control module 500 according to the embodiment.

The UPnP renderer control module 500 is provided with an AV transport module 501, connection manager module 502, and rendering control module 503, and the like.

The AV transport module 501 provides a control function associated with transfer of content. The connection manager module 502 provides the mechanism for exchange of information such as a protocol and encoding format utilizable in the first to third media renderers 21 to 23 to other devices and apparatuses. The rendering control module 503 provides the mechanism for managing parameters such as the sound volume, luminance, and the like at the time of playback.

Next, the configuration of each of the first to third media servers 11 to 13 will be described below with reference to FIG. 11. FIG. 11 is a block diagram showing the configuration of each of the media servers 11 to 13 according to the embodiment. Each of the media servers 11 to 13 is provided with a UPnP server control module 600, content directory module 601, connection manager module 602, storage device 611, LAN controller 612, and the like.

The storage device 611 is a solid-state drive (SSD) constituted of a hard disk drive in which application software and contents are stored, and nonvolatile memory such as a flash memory, and the like. The LAN controller 612 is a controller configured to carry out TCP/IP communication with the devices and apparatuses connected to the home network 50. The content directory module 601 manages metadata of content accumulated in the storage device 611. The connection manager 602 provides the mechanism for exchange of device information of the media servers 11 to 13 such as a protocol, and the like utilizable in the media servers 11 to 13.

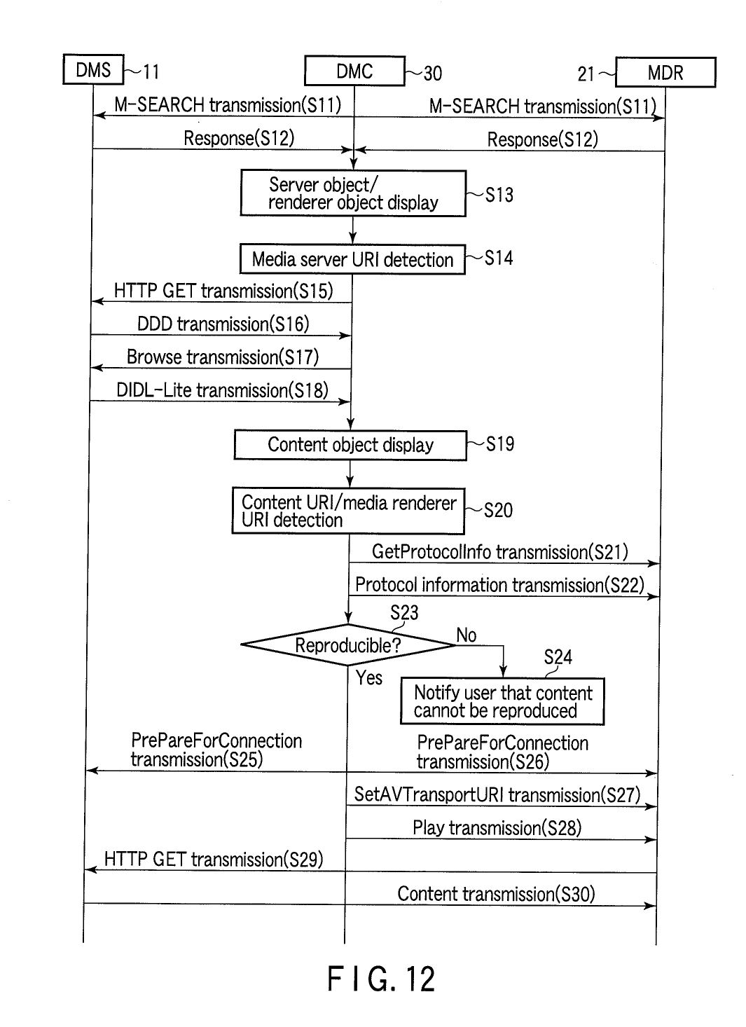

Next, the procedure for playing back content will be described below with reference to the flowchart of FIG. 12. FIG. 12 is a flowchart showing the procedure for playing back content according to the embodiment.

First, when the UPnP AV device control module 300 of the computer 30 is booted up, the device detection module 301 sends an M-SEARCH message defined by the SSDP to the home network 50 by multicast transmission (block S11). Each of the media servers 11 to 13, and playback apparatuses (media renderers) such as the first to third media renderers 21 to 23, which are compatible with UPnP, and which have received the M-SEARCH message transmits information such as a URI (IP address and port number) or the like indicating a position of its own device to the device which has transmitted the M-SEARCH message by including the information in an advertising message (block S12). The device detection module 301 detects all the first to third media servers 11 to 13, and first to third media renderers 21 to 23 connected to the home network 50 by receiving the advertising messages.

The display module 302 produces data for displaying the objects 211 to 213, and 221 to 223 correlated with the information on the media servers and media renderers from among the devices detected by the device detection module 301 in the window (FIG. 4) on the liquid crystal display 105 (block S13). The user operates the keyboard 106, whereby the server URI acquisition module 303 detects the selected server object from the server objects 211 to 213, and acquires a URI correlated with the detected server object (block S14). It is assumed here that a URI of the first media server 11 correlated with the first server object is detected.

The server information acquisition module 304 transmits an HTTP GET message to the URI acquired by the server URI acquisition module 303 (block S15). The connection manager module 602 of the first media server 11 which has received the HTTP GET message transmits a DDD in the XML format in which device information and service information are described to the computer 30 which is the transmission source (block S16). The server information acquisition module 304 receives the DDD file transmitted from the first media server 11.

The content list acquisition module 305 transmits a Browse action according to Content Directory Service (CDS) to the media server (first media server 11) detected by the server URI detection module 303 (block S17). The content directory module 601 of the media server (first media server 11) which has received the Browse action transmits a DIDL-Lite document in the XML format including information on the list of the contents stored in the storage device 611 to the computer 30 (block S18). The content list acquisition module 305 of the computer 30 receives the DIDL-Lite document.

The display module 302 of the computer 30 produces data for displaying the content objects 231 to 236 corresponding to the media contents stored in the storage device 611 of the first media server 11 in the window on the basis of the DIDL-Lite document received by the content list acquisition module 305. Further, the display module 302 displays the window 201 shown in FIG. 5 on the basis of the produced data (block S19).

The content URI acquisition module 307 acquires a URI of content correlated with a content object dragged by a drag-and-drop operation. Further, the renderer URI acquisition module 308 acquires a URI of a media renderer (first media renderer 21) correlated with a renderer object at which the content object is dropped by the drag-and-drop operation (block S20).

The renderer information acquisition module 310 transmits a GetProtocolInfo request to the URI of the media renderer acquired by the renderer URI acquisition module 308 (block S21). When the first media renderer 21 receives the GetProtocolInfo request, the connection manager module 502 uses the LAN controller 421 to transmit protocol information including the transmission protocol and encoding format with which the first media renderer 21 is compatible to the computer 30 (block S22). The renderer information acquisition module 310 acquires the protocol information transmitted by the first media renderer 21.

The determination module 311 determines whether or not the media content selected by the user can be played back by the first media renderer 21 (block S23). The determination module 311 determines whether or not the media content selected by the user can be played back by the first media renderer 21 through the following procedure.

The protocol determination module 311A reads the transmission protocol with which the media server is compatible from the DDD file. Further, the protocol determination module 311A reads the transmission protocol with which the first media renderer 21 is compatible from the protocol information transmitted from the first media renderer 21. Further, the protocol determination module 311A determines whether or not the first media renderer 21 is compatible with the transmission protocol with which the first media server 11 is compatible. When it is determined by the protocol determination module 311A that the first media renderer 21 is not compatible with the transmission protocol (No in block S23), the determination module 311 executes processing for notifying the user that the content cannot be played back (block S24).

When it is determined by the protocol determination module 311A that the first media renderer 21 is compatible with the transmission protocol, the encoding format determination module 311B reads the encoding format correlated with the dragged content object 231 from the DIDL-Lite document. The encoding format determination module 311B reads the encoding format with which the first media renderer 21 is compatible from the protocol information. Further, the encoding format determination module 311B determines whether or not the first media renderer 21 is compatible with the encoding format of the media content. When it is determined by the encoding format determination module 311B that the first media renderer 21 is not compatible with the encoding format of the media content (No in block S23), the determination module 311 executes processing for notifying the user that the media content cannot be played back (block S24).

When it is determined by the encoding format determination module 311B that the first media renderer 21 is compatible with the encoding format of the media content (Yes in block S23), the playback control module 312 transmits a PrePareForconnection action to the connection manager module 602 of the first media server 11, whereby the playback control module 312 instructs the first media server 11 to prepare for connection to the first media renderer 21 (block S25). Further, when a response to the PrePareForConnection action is received from the first media server 11, the playback control module 312 transmits a PrePareForconnection action to the connection manager module 502 of the first media renderer 21, whereby the playback control module 312 instructs the first media renderer 21 to prepare for connection to the first media server 11 (block S26). Further, when a response to the PrePareForConnection action is received from the first media renderer 21, the playback control module 312 transmits a SetAVTransportURI to the AV transport module 501 of the first media renderer 21 (block S27). In the parameter of the SetAVTransportURI, a URI acquired by the content URI acquisition module 307 is embedded. It should be noted that although it is described here that the PrePareForConnection is controlled, the block associated with the PrePareForConnection may be skipped.

Further, the playback control module 312 transmits a Play to the first media renderer 21 (block S28). When the first media renderer receives the Play, the AV transport module 501 transmits an HTTP::GET action to the first to third media servers 11 to 13 (block S29). In the HTTP::GET action, a URI acquired by the content URI acquisition module 307 is embedded as a parameter. The content directory module 601 of the first media server 11 transmits data of media content to the first media renderer 21 in accordance with the parameter of the HTTP::GET action (block S30).

Further, the first media renderer 21 acquires the data of the media content transmitted from the first media server 11 by way of HTTP, and carries out stream playback. At a point at which acquisition of data of a predetermined amount has been completed, the first media renderer starts playback of the media content.

By the processing described above, it is possible to easily grasp the digital media renderers existing on the network, and it becomes possible to easily grasp the selection of the digital media content, and digital media renderer.

It should be noted that in the embodiment described above, although the description has been given by using an example in which the function of the digital media server, and function of the digital media controller are incorporated in different devices separate from each other, the function of the digital media server, and function of the digital media controller may be incorporated in the same device.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A control apparatus comprising:
a server detector configured to detect a digital media server connected to a network;
a renderer detector configured to detect a digital media renderer connected to the network;
an information acquisition module configured to acquire content information from the digital media server, the content information comprising one or more network addresses of one or more digital media contents comprised in the digital media server;
a display module configured to display a window in a first window state or a second window state on a display screen of a display device;
an operation module configured to perform a drag-and-drop operation of a content object of one or more content objects in accordance with a user operation when the window in the second window state is displayed, the drag-and-drop operation comprising dragging the content object and dropping the content object at a renderer object; and
a command transmission module configured to transmit, to the digital media renderer, a network address of a digital media content corresponding to the content object and a command to playback the digital media content, the digital media server corresponding to the renderer object at which the content object is dropped,
wherein the display module is configured to display a server object corresponding to the digital media server in a first area of the window and the renderer object corresponding to the digital media renderer in a second area of the window when the window is in the first window state,
wherein the display module is configured to display the window in the second window state when the server object is selected, and
wherein the display module is configured to display the one or more content objects in the first area and the renderer object in the second area when the window is in the second window state, the one or more content objects corresponding to the one or more digital media contents comprised in the digital media server corresponding to the selected server object.

2. The control apparatus of claim 1, wherein
the content information further comprises one or more names of the one or more digital media contents,
the display module is configured to display, in the second area, a name of the digital media content based on the content information and a control button in order to control the playback of the digital media content, after the command transmission module transmits the command.

3. The control apparatus of claim 2, wherein
the display module is configured to display a changeover button in the second area; and
the display module is configured to switch, in accordance with operation of the changeover button, between a display of a name of the digital media content and the control button, and a display of names of both the digital media content and another digital media content that corresponds to another content object dropped at the renderer object by the drag-and-drop operation.

4. The control apparatus of claim 1, wherein
the content information comprises encoding formats of the one or more digital media contents,
wherein the control apparatus further comprises:
an encoding format acquisition module configured to acquire, from the digital media renderer, an encoding format with which the digital media renderer is compatible; and
a determination module configured to determine whether the digital media renderer can play back the digital media content based on the content information and the encoding format acquired from the digital media renderer.

5. A control method comprising:
detecting one or more digital media servers which are connected to a network and comprise one or more digital media contents;
detecting one or more digital media renderer connected to the network;
displaying one or more server objects, each corresponding to the one or more digital media servers, in a first area in a window to be displayed on a display screen of a display, and one or more renderer objects each corresponding to the one or more digital media renderer in a second area in the window;
displaying a content object corresponding to the digital media content in the first area and the one or more renderer object in the second area when one of the one or more server objects is selected, the digital media content comprised by the server corresponding to the selected server object; and
transmitting, when the content object is dragged and dropped at the renderer object by a drag-and-drop operation, a network address of the digital media content and a command to play back the digital media content to the digital media renderer, the digital media content corresponding to the content object and the digital media renderer corresponding to the renderer object.

6. A non-transitory computer readable medium having stored thereon a computer program which is executable by a computer, the computer program being configured to control the computer to execute functions of:
detecting one or more digital media servers which are connected to a network and comprise one or more digital media contents;
detecting one or more digital media renderer connected to the network;
displaying one or more server objects, each corresponding to the one or more digital media servers, in a first area in a window to be displayed on a display screen of a display, and one or more renderer objects each corresponding to the one or more digital media renderer in a second area in the window;
displaying a content object corresponding to the digital media content in the first area and the one or more renderer object in the second area when one of the one or more server objects is selected, the digital media content comprised by the server corresponding to the selected server object; and
transmitting, when the content object is dragged and dropped at the renderer object by a drag-and-drop operation, a network address of the digital media content and a command to play back the digital media content to the digital media renderer, the digital media content corresponding to the content object and the digital media renderer corresponding to the renderer object.
